(19) United States
(12) Patent Application Publication
(10) Pub. No.: US 2007/0222976 A1
(43) Pub. Date: Sep. 27, 2007

(54) Visual inspection apparatus

(75) Inventor: Katsuyuki Hashimoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/728,292

(22) Filed: Mar. 23, 2007

(30) Foreign Application Priority Data
Mar. 24, 2006 (JP) P 2006-083169

(51) Int. Cl. G01N 21/88

(52) U.S. Cl. 356/237.2

(57) ABSTRACT

A visual inspection apparatus includes: at least two inspection object transfer portions that transfer inspection objects to and from storage cassettes; at least two inspection portions that are located in different inspection positions from each other in order to inspect the inspection objects; an inspection object moving portion that moves the inspection objects that have been transferred to a main body of the apparatus between the inspection object transfer portions and the inspection portions, or between two of the inspection portions; and an inspection object transporting portion that transfers the inspection objects between the inspection object transfer portions and the storage cassettes.

### BACKGROUND OF THE INVENTION

1. Field of the Invention

The present invention relates to a visual inspection apparatus and to a visual inspection apparatus that makes an inspection by transporting an object of inspection that is formed by a substrate such as, for example, a semiconductor wafer to a plurality of inspection positions.

Priority is claimed on Japanese Patent Application No. 2006-083169, filed Mar. 24, 2006, the contents of which are incorporated herein by reference

2. Description of the Related Art

Conventionally, in a manufacturing process of, for example, a semiconductor wafer or the like, a visual inspection is performed in order to check whether or not any defects such as scratches in the wafer surface, dust adhesion, or film thickness abnormalities or the like have occurred and to check the positions of such occurrences. A plurality of inspections are included in an inspection such as this such as, for example, a macro inspection in which the entire surface of an object being inspected is illuminated and any defects are detected visually, and a micro inspection in which a portion of the object being inspected is partially enlarged and the defect position and defect type and the like are examined in more detail. A visual inspection apparatus is known that enables this plurality of inspections to be performed by a solitary inspector.

In FIG. 1 of Japanese Patent Application Laid-Open (JP-A) No. 2002-252265, an apparatus for transporting and inspecting a semiconductor substrate is described as an example of this type of visual inspection apparatus. In this apparatus, a substrate that is supplied from a cassette is transported as an object for inspection to a delivery position by a manufacturing process. The substrate is then delivered to a switching device that switches the substrate position by rotating an arm that is isometrically divided so as to extend in three directions. As a result of this switching device being operated, the substrate is then transported in sequence to first, second, and third workstations where inspections can be made by a macro inspection portion and a micro inspection portion that are provided respectively at the second and third work stations.

However, problems such as those described below have occurred in the above described conventional visual inspection apparatus.

In the technology described in JP-A No. 2002-252265, because a substrate needs to transit the delivery position when it is being both supplied and retrieved, it is necessary for a substrate that has completed inspection and a substrate that has yet to undergo inspection to be switched with each other at the delivery position. As a result, because it is not possible during the switching operation to move substrates that have been placed on the respective inspection portions, the problem arises that efficient inspections cannot be made.

### SUMMARY OF THE INVENTION

The present invention was conceived in view of the above described problems and it is an object thereof to provide a visual inspection apparatus that makes it possible to efficiently move an object of inspection and makes it possible to improve inspection efficiency.

In order to solve the above described problerns, the visual inspection apparatus of the present invention includes: at least two inspection object transfer portions that transfer inspection objects to and from storage cassettes; at least two inspection portions that are located in different inspection positions from each other in order to inspect the inspection objects; an inspection object moving portion that moves the inspection objects that have been transferred to a main body of the apparatus between the inspection object transfer portions and the inspection portions, or between two of the inspection portions; and an inspection object transporting portion that transfers the inspection objects between the inspection object transfer portions and the storage cassettes.

### BRIEF DESCRIPTION OF THE DRAWINGS

FIG. 1 is a plan view showing the schematic structure of a visual inspection apparatus according to a first embodiment of the present invention.

FIG. 2 is a functional block diagram showing the schematic structure of a control unit of the visual inspection apparatus according to the first embodiment of the present invention.

FIG. 3 is a flow chart showing a portion of an operation of the visual inspection apparatus according to an embodiment of the present invention.

FIG. 4 is a plan view showing the schematic structure of the visual inspection apparatus according to a second embodiment of the present invention.

FIG. 5 is a functional block diagram showing the schematic structure of a control unit of the visual inspection apparatus according to the second embodiment of the present invention.

FIG. 6 is a flow chart showing a portion of an operation of the visual inspection apparatus according to the second embodiment of the present invention.

FIG. 7 is a plan view showing the schematic structure of the visual inspection apparatus according to a reference example.

FIG. 8 is a flow chart showing an example of an operation of the visual inspection apparatus according to a reference example.

FIG. 9 is a flow chart showing another example of an operation of the visual inspection apparatus according to a reference example.

### DETAILED DESCRIPTION OF THE INVENTION

Embodiments of the present invention are described below with reference made to the attached drawings. In each of the drawings the same symbols are given to the same or corresponding components even when the embodiments are different and any duplicated description thereof is omitted.

### First Embodiment

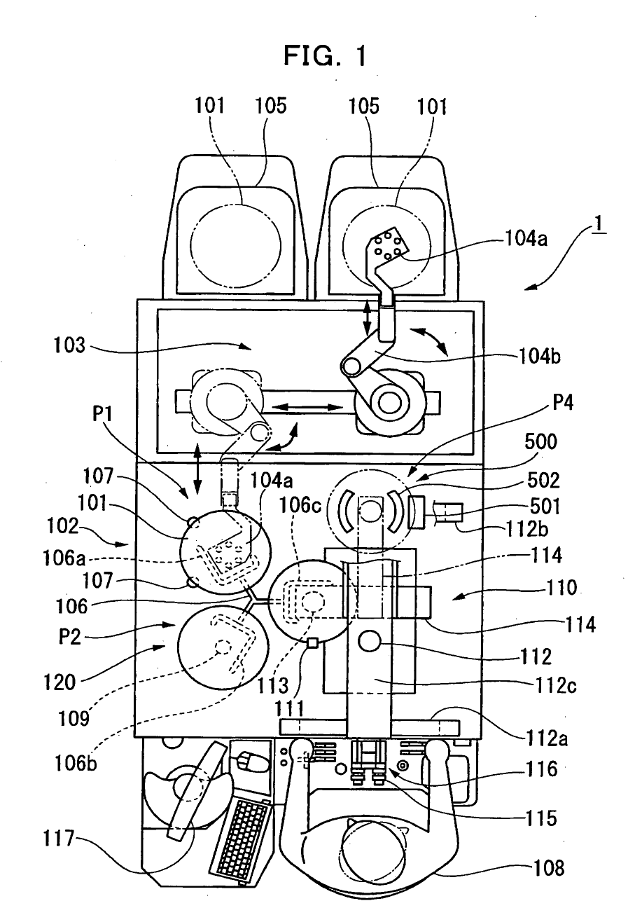

FIG. 1 is a plan view showing the schematic structure of a visual inspection apparatus according to a first embodiment of the present invention.

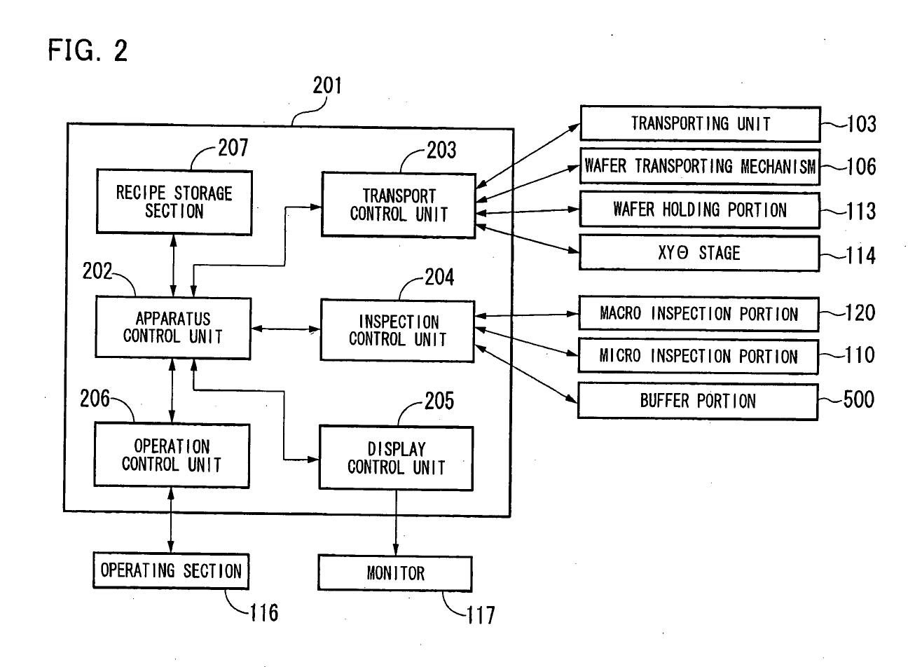

FIG. 2 is a functional block diagram showing the schematic structure of a control unit of the visual inspection apparatus according to the first embodiment of the present invention.

As is shown in FIG. 1, the visual inspection apparatus 1 of the present embodiment performs a visual inspection by receiving into an apparatus main body as objects for inspection a plurality of semiconductor wafers 101 that are stored in a wafer cassette 105 (i.e., a storage cassette). At least two types of visual inspection including a macro inspection in which the entire surface of the semiconductor wafer 101 is illuminated and whether or not any defects such as scratches in the wafer surface, dust adhesion, or film thickness abnormalities or the like have occurred as well as the positions of such occurrences are checked, and a micro inspection in which the surface of the semiconductor wafer 101 is partially enlarged and the defect size, shape, and type and the like are checked are performed alternatingly by a solitary inspector 108.

The semiconductor wafer 101 is formed in a substantially circular shape, and a shape that is used to set a reference position for the semiconductor wafer 101, for example a reference notch (not shown), is provided in a portion of the circumference thereof.

The structure of the visual inspection apparatus 1 is schematically formed by a transporting unit 103, an inspection unit 102, an operating section 116, and a control unit 201 (see FIG. 2).

The transporting unit 103 supplies uninspected semiconductor wafers 101 that are set in the wafer cassette 105 to the inspection unit 102, and discharges semiconductor wafers 101 that have completed the inspection of the inspection unit 102 to the wafer cassette 105, and comprises a wafer manufacturing process 104 (i.e., inspection object transporting portion) that transfers the semiconductor wafers 101 between the wafer cassette 105 and the inspection unit 102.

In the present embodiment, two wafer cassettes 105 can be fitted parallel to each other in an end portion of the transporting unit 103, and the wafer manufacturing process 104 is provided so as to be able to move in a horizontal direction in this parallel direction (i.e., in the left and right directions in FIG. 1).

The structure of the wafer manufacturing process 104 is schematically formed by an expanding arm 104b having a turn center axis in a robot main body that is provided so as to be able to move up and down and whose turning radius can be expanded or contracted, and by a holding portion 104a that is provided at a distal end portion of the expanding arm 104b and is used to hold the semiconductor wafer 101 by suction.

The range of horizontal movement, vertical movement, and turning movement of the wafer manufacturing process 104 is set so as to enable the holding portion 104a to extract or replace an optional semiconductor wafer 101 of the wafer cassette 105, and so as to enable a suctioned semiconductor wafer 101 to be moved to wafer transfer positions P1 and P4 of the inspection unit 102 (described below).

The inspection unit 102 performs at least a macro inspection and a micro inspection on a semiconductor wafer 101 that has been transported from the transporting unit 103. In the present embodiment, the inspection unit 102 is provided adjacent to the opposite side from the wafer cassettes 105 and 105.

The structure of the inspection unit 102 is schematically formed by a wafer transporting mechanism 106 (i.e., a sequential movement mechanism), a macro inspection mechanism 120 (i.e., an inspection portion), a micro inspection portion 110 (i.e., an inspection portion), and a buffer portion 500 (i.e., an inspection object transfer portion).

The wafer transporting mechanism 106 comprises three transfer arms 106a, 106b, and 106c that extend from a rotation axis which runs in a vertical direction in radial directions that are each equally separated by 120 degrees, and that hold a semiconductor wafer 101 at a distal end side in the radial direction on a circumference having a fixed radius. These transfer arms are able to make turning movements of 120 degrees within a horizontal plane, and vertical movements at positions where a turning movement is stopped.

As a result, semiconductor wafers 101 that are held by suction on the transfer arms 106a, 106b, and 106c are able to move consecutively in sequence between three stopping positions on the same circumference.

In the present embodiment, three positions P1, P2, and P3 are set at equal angle pitches of 120 degrees on the same circumference as stopping positions for the turning movements. P1 is a wafer transfer position (i.e., an inspection object transfer portion) where semiconductor wafers 101 are transferred with the wafer manufacturing process 104. P2 is a macro inspection position where macro inspections are performed. P3 is a micro inspection transfer position where the semiconductor wafers 101 are transferred to the micro inspection portion 110 in order for a micro inspection to be performed.

As is shown in FIG. 1, the respective stopping positions P1 and P2 are set along the left side in the drawing with the wafer transfer position P1 on the transporting unit 103 side, and the macro inspection position P2 on the operating section 116 side that is located on the opposite side from the transporting unit 103. The micro inspection transfer position P3 is located on the right side in the drawing at an intermediate position between P1 and P2.

Pre-centering units 107 that detect an edge of a semiconductor wafer 1 in order to correct any mispositioning of the semiconductor wafer 101 from the center of the wafer transfer position P1 during an operation of the wafer manufacturing process 104 to transfer the semiconductor wafer 101 to the wafer transfer position P1 are located at the wafer transfer position P1.

The pre-centering units 107 comprise two light quantity detecting sensors that are located in the vicinity of the edge of a semiconductor wafer 101 in angular directions that are at right angles with each other when the center of the reference position of the semiconductor wafer 101 is taken as the intersection point. The amount of offset from the reference position of the schematic wafer center is detected from a table showing the change in the light amount that has been measured in advance and the wafer position.

The macro inspection portion 102 comprises a macro illumination portion (not shown) that illuminates the entire surface of a substrate wafer 101 that has been moved to the macro inspection position P2 and a macro inspection oscillating mechanism 109.

The macro inspection oscillating mechanism 109 holds by suction a semiconductor wafer 101 that has been moved to the macro inspection position P2 and causes it to oscillate, and is provided so as to be able to move up and down at the center position of the macro inspection position P2. The oscillation operation of the macro inspection oscillating mechanism 109 is controlled by the control unit 201 (described below) based on operations of an inspector 108 through the operating section 116 or based on oscillation data that has been stored in advance.

The micro inspection portion 110 comprises a wafer holding portion 113 (i.e., transfer movement portion), an alignment sensor 111, and a microscope 112.

The wafer holding portion 113 holds a semiconductor wafer 101 by suction such that it can be freely removed or mounted, and moves between the micro inspection transfer position P3, the inspection position of the micro inspection portion 110, and the wafer transfer position P4 adjacent to the micro inspection portion 110.

The wafer holding portion 113 of the present embodiment is placed on an XYΘ stage 114 that is capable of moving in two axial directions and a rotation direction within a horizontal plane.

Note that it is also possible to employ a structure in which the holding position of the semiconductor wafer 101 can be raised or lowered if necessary. Namely, the XYΘ stage may be formed as an XYZΘ stage.

In the present embodiment, the wafer transfer position P4 is set to a position between the micro inspection portion 110 and the transporting unit 103.

The alignment sensor 111 is a sensor that detects a circumferential end surface portion and the reference notches of a semiconductor wafer 101 in order to detect center position offset as well as angular offset of the semiconductor wafer 101 that has been transferred at the micro inspection transfer position P3 from the wafer transporting mechanism 106 to the wafer holding portion 113.

The microscope 112 is used to allow an enlargement of a semiconductor wafer 101 that has been moved to the inspection position by the wafer holding portion 113 to be observed. In the present embodiment, a microscope main body 112c that comprises an objective lens (not shown), an image pickup device such as a CCD camera, and an ocular lens 115 that is used by an inspector 108 to make direct observations is held above the XYΘ stage 114 by supporting column portions 112a and 112b that are located at positions where they do not obstruct the movement of the wafer transporting mechanism 106 and a semiconductor wafer 101 that is held on the wafer holding portion 113.

Images obtained by the image pickup device are able to be displayed on a monitor 117.

The buffer portion 500 is used to hold a semiconductor wafer 101 that has been moved to the wafer transfer position P4 by the wafer holding portion 113 until it is transferred to the wafer manufacturing process 104. Namely, in the present embodiment an example is described in which the wafer transfer position P4 also functions as a buffer position (therefore, in the description of the present embodiment, the wafer transfer position P4 may in some cases be referred to as the buffer position P4). In addition, in the present embodiment there is provided a buffer portion holding stage 502 that holds a semiconductor O1 by suction without interfering with the wafer holding portion 113 and the holding portion 104a of the wafer manufacturing process 104, and rotates the semiconductor wafer 101 around its center after the wafer holding portion 113 and the holding portion 104a have been withdrawn.

Note that it is also possible to provide a bevel inspection unit 501 that inspects outer circumferential edge portions (i.e., bevel portions) of a semiconductor wafer 101 at the wafer transfer position P4. At this time, an example is given in which the buffer portion 500 is an inspection object transfer portion and comprises a bevel inspection unit 501 which forms an auxiliary inspection portion that performs different types of inspection from the macro inspection portion 110 and the micro inspection portion 120.

In this manner, in the visual inspection apparatus 1, the wafer transporting mechanism 106 and the wafer holding portion 113 constitute inspection object moving portions that respectively move an inspection object that has been transferred to a main body of the apparatus between the inspection object transfer portion and the inspection portion or between two inspection portions.

The operating section 116 is used by an inspector 108 to make operational inputs into the visual inspection apparatus 1 via the control unit 201, and is provided adjacent to the inspection unit 102 on the opposite side from the transporting unit 103. Specifically, a suitable operational input device is provided such as, for example, a joystick, buttons, a dial, a lever, a mouse and keyboard or the like in accordance with the type of input operation.

The control unit 201 is electrically connected to the transporting unit 103, the inspection unit 102, and the operating section 116 and is used to control the respective operations thereof.

As is shown in FIG. 2, the structure of the control unit 201 is schematically formed by a transport control unit 203 that is connected to the transporting unit 103, the wafer transporting mechanism 106, the wafer holding portion 113, and the XYΘ stage 114 and controls the operations thereof, an inspection control unit 204 that is connected to the macro inspection portion 120, the micro inspection portion 110, and the buffer portion 500 and controls the operations thereof, a display control unit 205 that displays on the monitor 117 various types of setting information for a main body of the apparatus as well as apparatus information relating to the current inspection and movement, an operation control unit 206 that receives operational inputs from the operating section 116 and converts them into suitable control signals, a recipe storage portion 207 that stores and holds various setting information that is required in order to perform the respective inspections as well as information on inspection objects, and the apparatus control unit 202.

The apparatus control unit 202 is electrically connected to each of the transport control unit 203, the inspection control unit 204, the display control unit 205, the operation control unit 206, and the recipe storage portion 207, and communicates with each of these so as to control the operations of each. As a result, the apparatus control unit 202 is able to perform the overall control of the apparatus.

This type of control unit 201 may be realized using dedicated hardware for the functional blocks shown in FIG. 2, however, in the present embodiment, a computer having a central processing unit (CPU), a memory, an input/output interface, an external storage section, and the like is employed. Each control unit is realized by a program that performs operations corresponding to the respective functions, and the recipe storage portion 207 is provided in an external storage section.

Next, operations of the visual inspection apparatus 1 will be described, mainly with regard to movement operations of the semiconductor wafer 101.

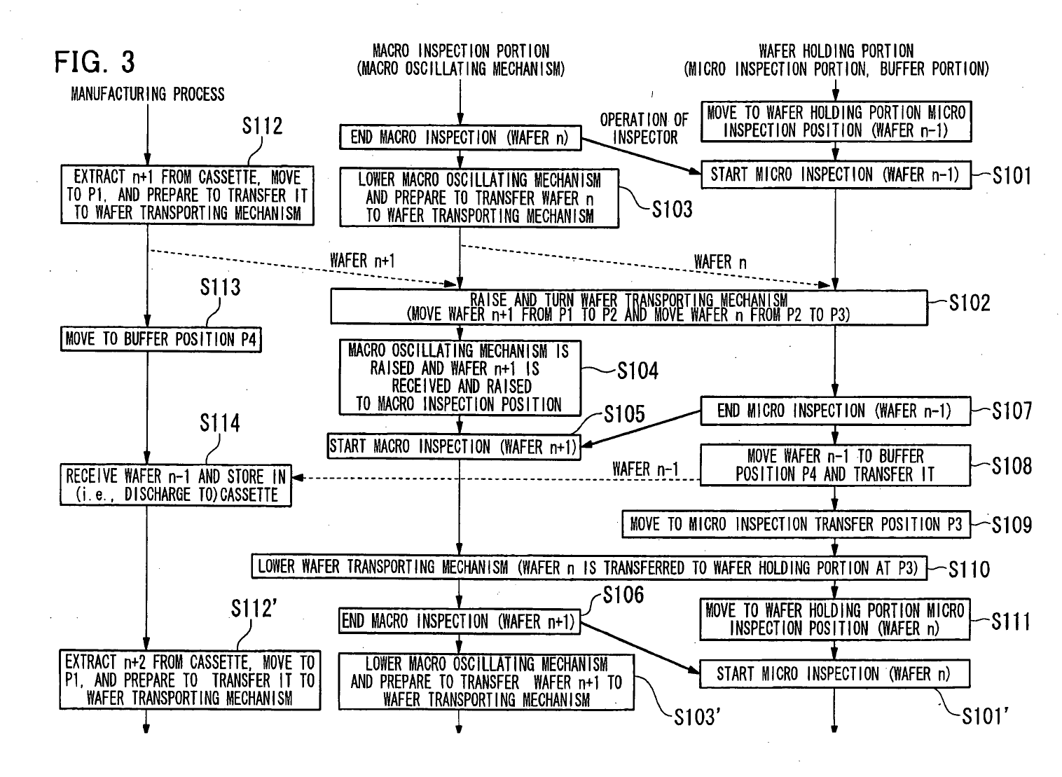

FIG. 3 is a flow chart showing a portion of operations of the visual inspection apparatus according to an embodiment of the present invention.

When a wafer cassette 105 is connected to the apparatus main body, information relating to the semiconductor wafers 101 inside the wafer cassette 105 is fed to the control unit 201, and information required for an inspection as well as information relating to each semiconductor wafer 101 are stored in the recipe storage portion 207 via the apparatus control unit 202. The information that is stored in the recipe storage portion 207 is displayed on the monitor 117 via the display control unit 205.

An operator 108 selects a semiconductor wafer 101 to be inspected and selects the type of inspection based on information displayed on the monitor 117, and inputs them from the operating section 116. Hereinafter, it will be assumed that a plurality of semiconductor wafers 101 have been selected for the inspection sequence, and movement operations are described for an n^{th} (wherein n is an integer) semiconductor wafer 101 with other semiconductor wafers 101 positioned to the front and rear thereof. Unless special mention is made to the contrary, the term ‘semiconductor wafer 101’ refers to this n^{th} semiconductor wafer, however, if it is necessary to make a distinction between a plurality of semiconductor wafers 101, then the (n±k)^{th} (wherein k is an integer) semiconductor wafer 101 is distinguished by being described as semiconductor wafer 101(n±k).

The wafer manufacturing process 104 that has discharged a semiconductor wafer 101(n−3) which has completed the inspection of the previous step to the discharge wafer cassette 105 moves to the inside of the supply wafer cassette 105 in which uninspected semiconductor wafers 101 have been set, and holds a semiconductor wafer 101(n) by suction. The semiconductor wafer 101(n) is then transported to the wafer transfer position P1. The position in the height direction of the semiconductor wafer 101(n) at this time is taken as h₀.

Position correction is performed by the wafer manufacturing process 104 in order to match the center position of the semiconductor wafer 101(n) to the center of the wafer transfer position P1 using the pre-centering units 107.

After macro inspection of the semiconductor wafer 101(n−1) has ended, the suctioning of the semiconductor wafer 101 by the holding portion 104a is terminated, and the wafer transporting mechanism 106 is raised from a bottom side wait position h₁ (wherein h₁<h₀) to a predetermined turn position h₂ (wherein h₂>h₀). For example, at the wafer transfer position P1, the transfer arm 106a is raised from the position h₁ to h₂, and at the position h₀ during this process, the semiconductor wafer 101(n) is transferred to the transfer arm 106a.

After this transfer has been completed, the wafer manufacturing process 104 withdraws from the wafer transfer position P1 and performs the discharge of a semiconductor wafer 101(n−2).

In this state of being raised to h₂, the wafer transporting mechanism 106 is turned 120° counterclockwise as seen in FIG. 1, and the semiconductor wafer 101(n) is moved to the macro inspection position P2. At the same time, the empty transfer arm 106c is moved to the wafer transfer position P1.

Note that during this turning, the macro inspection oscillating mechanism 109 is lowered to a position H where it does not interfere with the wafer transporting mechanism 106. The transfer arm 106a holds the semiconductor wafer 101 by suction.

Next, the suction of the transfer arm 106a is terminated, the macro inspection oscillating mechanism 109 is raised, and during this process, the semiconductor wafer 101 is transferred to the macro inspection oscillating mechanism 109 at the position h₀.

After this delivery, the macro inspection oscillating mechanism 109 suctions the semiconductor wafer 101, and raises it to a predetermined inspection height. As a result, preparation for the macro inspection of the semiconductor wafer 101(n) is completed.

During this, the inspector 108 makes a micro inspection of the semiconductor wafer 101(n−2) that has been moved to the micro inspection position (i.e., a position where a portion of the inspection object is directly beneath the objective lens of the microscope).

When the semiconductor wafer 101(n−2) micro inspection step has ended, the inspector 108 makes a macro inspection of the semiconductor wafer 101(n) for which preparations have already been completed. Namely, using the operating section 116, the macro inspection oscillating mechanism 109 is made to oscillate, and the entire surface of the semiconductor wafer 101 is illuminated by an illumination portion (not shown) so that a visual inspection of any defects can be made.

Next, depending on whether or not any defects are present, post-inspection processing such as the registering of any defects or the like is performed. After this, the macro inspection step for the semiconductor wafer 101(n) is ended. At the same time as this, the inspector 108 starts the micro inspection of the semiconductor wafer 101(n−1) (step S101).

The oscillating state of the semiconductor wafer 101(n) that is suctioned by the macro inspection oscillating mechanism 109 is restored to horizontal, and the suctioning by the macro inspection oscillating mechanism 109 is terminated. The macro inspection oscillating mechanism 109 is then lowered, and preparations to transfer the semiconductor wafer 101(n) to the wafer transporting mechanism 106 are made (step S103).

Next, the wafer transporting mechanism 106 is raised from the position h₁ to h₂, and is turned 120° (step S102). In this step, at the wafer transfer position P1, in the same way as the above described semiconductor wafer 101, the position of the semiconductor wafer 101(n+1) is corrected by the pre-centering units 107, and is transferred to the transfer arm 106c. The semiconductor wafer 101(n+1) is then suctioned by the transfer arm 106c, and is moved to the macro inspection position P2 (step S102).

At the macro inspection position P2, the macro inspection oscillating mechanism 109 is raised and, at the position h₀, the semiconductor wafer out 101(n+1) is transferred in the same way as the above described semiconductor wafer 101.

At the macro inspection position P2, the semiconductor wafer 101(n+1) is suctioned by the macro inspection oscillating mechanism 109, the semiconductor wafer 101(n+1) is raised to a predetermined inspection height, and preparations for the macro inspection are completed (step S104).

After the micro inspection, the inspector 108 starts the macro inspection (step S105). In addition, the wafer holding portion 113 moves the semiconductor wafer 101(n−1) to the wafer transfer position P4, and transfers it to the buffer portion 500 (step S108).

In step S108, the XYΘ stage 114 is driven by control signals from the transport control unit 203, and the wafer holding portion 113 on which the semiconductor wafer 101(n−1) is held is moved to the wafer transfer position P4, and is transferred to the buffer portion holding stage 502. At this time, it may also be received directly by the transfer arm. Moreover, it is also possible for the buffer portion holding stage 502 to be raised up and receive the semiconductor wafer 101(n−1).

It is also possible to employ a structure in which the wafer holding portion 113 holds the semiconductor wafer 101 at a position that is higher than the height of the buffer portion holding stage 502, and for the suctioning of the wafer holding portion 113 to be terminated and the wafer holding portion 113 then lowered by the transport control unit 203 so that the semiconductor wafer 101(n−1) can be transferred to the buffer portion holding stage 502. At this time, the buffer portion holding stage 502 holds the semiconductor 101(n−1) by suction.

Subsequently, the wafer holding portion 113 is moved to the micro inspection transfer position P3 (step S109). As a result, once the transfer arm 106a has dropped below the height of the wafer holding portion 113, the semiconductor wafer 101(n) is transferred to the transfer arm 106a, and is held by suction on the wafer holding portion 113 (step S110).

At this time, by rotating the wafer holding portion 113, the reference notches in the semiconductor wafer 101 are detected by the alignment sensor 111, and the reference position of the semiconductor wafer 101 relative to the coordinate position of the wafer holding portion 113 is calculated. As a result, an optional position on the semiconductor wafer 101 can be matched by XYΘ stage 114 to an optional position within the movable range of the XYΘ stage 114.

Next, in step S111, based on information stored in advance in the recipe storage portion 207 and on results from the macro inspection of the semiconductor wafer 101 and the like, the XYΘ stage 114 is driven either automatically or manually, and the semiconductor wafer 101(n) that is held on the wafer holding portion 113 is moved to the inspection position.

By performing this step S111, preparations for the micro inspection step of the semiconductor wafer 101(n) are completed.

Because the steps S108 to S111 are performed automatically under the control of the transport control unit 203, an inspector 108 performs a macro inspection (step S105 to S106) at the macro inspection position P2 in parallel with this operation. Namely, the inspector 108 performs the macro inspection step for the semiconductor wafer 101(n+1).

After step S102, the wafer manufacturing process 104 moves to the wafer transfer position P4 (step S113). The semiconductor wafer 101(n−1) is then received by the holding portion 104a thereof.

The wafer manufacturing process 104 that is holding the semiconductor wafer 101(n−1) by suction then discharges (i.e., stores) the semiconductor wafer 101 to the discharge wafer cassette 105 (step S114). In addition, the semiconductor wafer 101(n+2) is extracted from the supply wafer cassette 105, and preparations are made to transfer it to the transfer arm 106b that is positioned at the wafer transfer position P1 (step 112′).

When steps S112′ and S103′ have ended, the next inspection cycle for the semiconductor wafer 101(n+1) becomes possible. Therefore, the above steps are repeated as required.

In this manner, an inspection cycle is realized in which a macro inspection and a micro inspection are performed in sequence on a plurality of semiconductor wafers 101 that are supplied in sequence from the wafer cassette 105 and are then discharged in this sequence to the discharge wafer cassette 105.

Note that, when the bevel inspection unit 501 is provided in the buffer portion 500, semiconductor wafers 101 that have been transferred to the buffer portion holding stage 502 at the wafer transfer position P4 may undergo a bevel inspection step prior to step S114. Namely, it is also possible to rotate the buffer portion holding stage 502 using the inspection control unit 204, and to inspect the front and rear surfaces as well as side surfaces of a bevel portion of the semiconductor wafer 101 in a circumferential direction using the bevel inspection unit 501.

In this manner, according to the visual inspection apparatus 1 of the present embodiment, micro inspection steps (steps S101 to S107) for the micro inspection for the (n−1)^{th} semiconductor wafer 101 and preparatory steps (steps S102 and S104) for the macro inspection step of the (n+1)^{th} semiconductor wafer 101 can be performed in parallel, and micro inspection preparatory steps (steps S103 and S102) for the micro inspection for the n^{th} semiconductor wafer 101 and a step to move the wafer manufacturing process 104 to the buffer position P4 (step S113) can be performed in parallel.

Furthermore, by providing the wafer transfer position P4 and the buffer portion 500, the steps (step S108 and S109) after the micro inspection step of the (n−1)^{th} semiconductor wafer 101, the preparatory steps (steps S110 to S111) for the n^{th} micro inspection step, and the discharge step to the wafer cassette 105 (step S114) can each be performed in parallel with the macro inspection steps (steps S105 to S106) for the (n+1)^{th} semiconductor wafer 101.

As a result, even if there is only one inspector 108, an inspection can be efficiently made.

In the present embodiment, an example is described of a case in which the inspection object moving portion is formed by a sequential movement mechanism and a transfer movement portion, and the transferor movement portion is provided on the terminal stopping position side.

In the present embodiment, because a new buffer portion is provided and a semiconductor wafer 101 can be delivered to the wafer manufacturing process 104 at this new buffer portion, other inspection apparatuses such as a bevel inspection apparatus can be provided in this buffer portion so that expansion capabilities are improved.

### Second Embodiment

A visual inspection apparatus according to the second embodiment of the present invention will now be described.

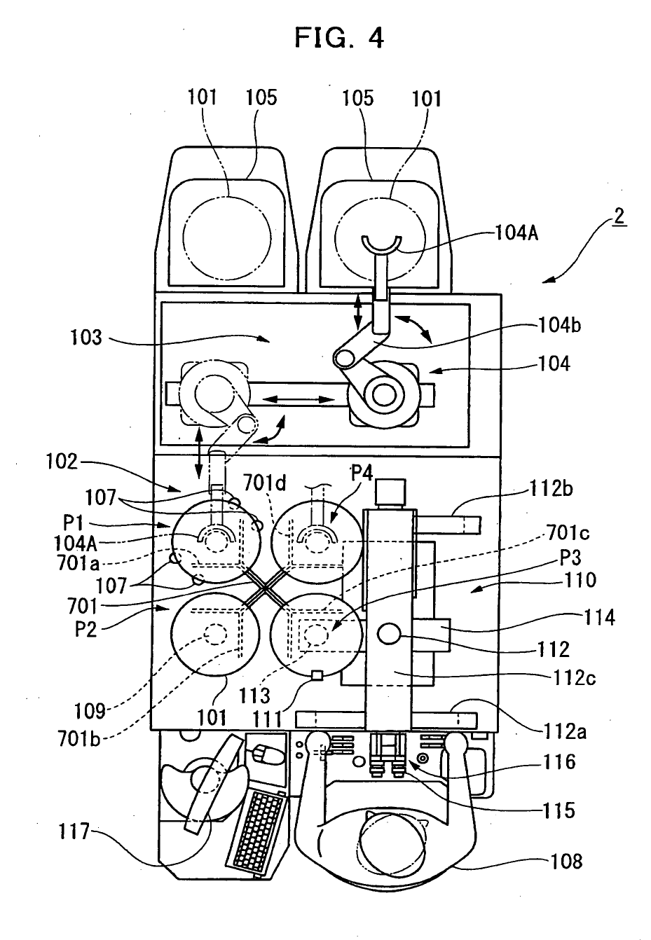

FIG. 4 is a plan view showing the schematic structure of the visual inspection apparatus according to the second embodiment of the present invention.

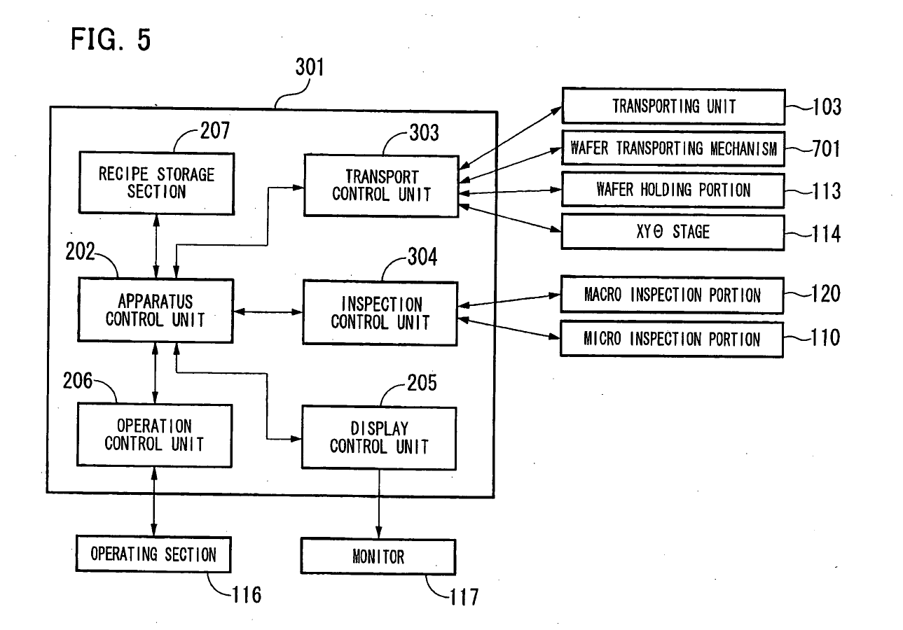

FIG. 5 is a functional block diagram showing the schematic structure of a control unit of the visual inspection apparatus according to the second embodiment of the present invention.

As is shown in FIG. 4, a visual inspection apparatus 2 of the present embodiment comprises a wafer transporting mechanism 701 (i.e. a sequential movement mechanism) in place of the wafer transporting mechanism 106 of the visual inspection apparatus 1 of the above described first embodiment. In addition, the buffer portion 500 is eliminated and, as is shown in FIG. 5, a control unit 301 is provided in place of the control unit 201. The description below concentrates on points of variance with the above described first embodiment.

The wafer transporting mechanism 701 comprises four transfer arms 701a, 701b, 701c, and 701d that extend from a vertically extending rotation axis in radial directions separated at 90 degree angles, and that hold by suction semiconductor wafers 101 on a fixed diameter circumference at the distal end side in the radial direction. These transfer arms are able to make turning movements of 90 degrees each within a horizontal plane, and are also able to move up and down at the turning movement stop positions.

As a result, the semiconductor wafers 101 that are held by suction by the transfer arms 701a, 701b, 701c, and 701d are able to move continuously in sequence between the four stop positions on the same circumference.

In the present embodiment, a wafer transfer position (i.e., an inspection object transfer portion) P1, a macro inspection position P2, a micro inspection transfer position P3, and a wafer transfer position P4 are set at equal angle pitches of 90 degrees on the same circumference as stopping positions for the turning movements.

As is shown in FIG. 4, the respective stopping positions P1 and P2 are set along the left side in the drawing with the wafer transfer position P1 on the transporting unit 103 side, and the macro inspection position P2 on the operating section 116 side that is located on the opposite side from the transporting unit 103. The wafer transfer position P4 and the micro inspection transfer position P3 are located on the right side in the drawing.

Moreover, in the same way as in the first embodiment, pre-centering units 107 are provided at the wafer transfer position P1, and an alignment sensor 111 is provided at the micro inspection transfer position P3.

Unlike the first embodiment, the pre-centering units 107 comprise four photosensor units. The photosensor units are transmission type or reflective type photodetectors. Correspondence tables for the positions of the semiconductor wafers 101 and detected light amounts are prepared in advance, and using at least three of the four sensors a semiconductor chip 101 is positioned so as substantially match the center of rotation of the macro inspection oscillating mechanism 109 and is transferred to the transfer arm 701a.

The control unit 301 is achieved by modifying operations of corresponding portions of the control unit 201 in accordance with the removal of the buffer portion 500 and the modifications to the wafer transporting mechanism 701, and, instead of the transport control unit 203 and the inspection control unit 204, comprises a transport control unit 303 and an inspection control unit 304.

Note that the holding portion 104a of the wafer manufacturing process 104 is replaced by a holding portion 104A in accordance with the modification of the wafer transfer position P4. As is shown in FIG. 4, in order that the holding portion 104A does not interfere with the wafer holding portion 113 when a transfer is performed at the wafer transfer position P4, the shape of the holding portion 104A when seen in plan view is formed as a U shape which curves around the wafer holding portion 113.

Next, an operation of the visual inspection apparatus 2 will be described concentrating on a movement operation of the semiconductor wafer 101.

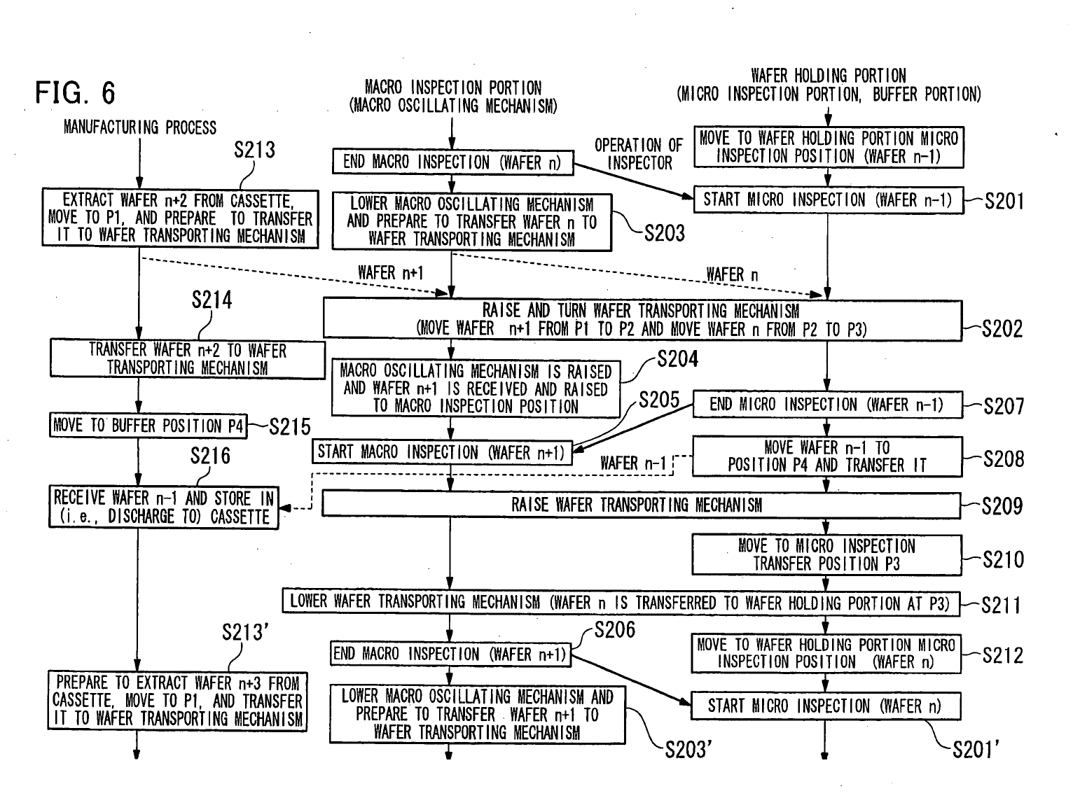

FIG. 6 is a flow chart showing a portion of operations of the visual inspection apparatus according to the second embodiment of the present invention.

The description below is of a case in which, as is shown in FIG. 6, a plurality of semiconductor wafers 101 are moved in sequence by the wafer transporting mechanism 701 and a macro inspection of the semiconductor wafers 101 has ended. In this state, the semiconductor wafer 101(n+1) is held on the transfer arm 701a that is positioned at the wafer transfer position P1, and the semiconductor wafer (n) is held on the transfer arm 701b that is positioned at the macro inspection position P2. In addition, the transfer arm 701c that is positioned at the micro inspection transfer position P3 is empty, while the semiconductor wafer 101(n−1) is held on the wafer holding portion 113 that is positioned at the micro inspection position.

The description also assumes that a micro inspection has commenced (step S201).

In step S213, the wafer manufacturing process 104 extracts the semiconductor wafer 101(n+2) from the wafer cassette 105, and preparations are made to move it to the wafer transfer position P1 and transfer it to the transporting mechanism 701.

Firstly, in step S202, the wafer transporting mechanism 701 is raised to the position h₂, turned 90° counterclockwise as is shown in FIG. 4, and lowered to the position h₀.

At this time, because the empty transfer arm 701d has been moved to the wafer transfer position P1, the wafer manufacturing process 104 is driven and the semiconductor wafer 101(n+2) is moved from the supply wafer cassette 105 over the transfer arm 701d, is transferred thereto, and is then held by suction (step S214).

The empty transfer arm 701c is also moved to the wafer transfer position P4.

In contrast, because the semiconductor wafer 101(n+1) has been moved to the macro inspection position P2, operational control for the preparatory steps for a macro inspection is conducted by the inspection control unit 304.

Namely, in step S204, the suction of the semiconductor wafer 101(n+1) is terminated, the macro inspection oscillating mechanism 109 is raised and the semiconductor wafer 101(n+1) is transferred to the macro inspection oscillating mechanism 109.

Furthermore, the macro inspection oscillating mechanism 109 suctions the semiconductor wader 101(n+1) and is raised to the inspection position.

Here, steps S201 to S207 are the same as steps S101 to S107 of the first embodiment Namely, these are steps in which an inspector 108 performs a micro inspection of the semiconductor wafer 101(n−1).

In step S207, the inspector instructs that the micro inspection be ended, and when the end thereof is detected by the inspection control unit 304, the routine moves to step S208. However, because the subsequent steps S208 to S212 are conducted automatically by the control of the transport control unit 303, in parallel with these operations the operator 108 moves to step S205 at the macro inspection position P2, and is able to perform the macro inspection step on the semiconductor wafer 101(n+1).

In step S208, the XYΘ stage 114 is driven by the transport control unit 303, and the wafer holding portion 113 on which the semiconductor wafer 101 is held is moved to the wafer transfer position P4. At this time, the wafer holding portion 113 and the transfer arm 701c are in a positional relationship whereby they do not interfere with each other.

Furthermore, in step S208, the suctioning of the wafer holding portion 113 is terminated and the semiconductor wafer 101(n−1) is transferred to the wafer holding robot 104. The wafer manufacturing process 104 holds the semiconductor wafer 101(n−1) by suction.

Next, in step S209, the wafer transporting mechanism 701 is raised up.

Note that it is also possible after the micro wafer holding portion 113 has moved to the wafer transfer position P4 in step S208, for step S209 to be conducted and for the semiconductor wafer 101(n−1) to be raised and transferred to the transfer arm 701c, and for this to be received by the wafer manufacturing process 104.

In step S210, the XYΘ stage 114 is driven by the transport control unit 203, and the wafer holding portion 113 is moved to the micro inspection transfer position P3.

Next, in step S211, as a result of the wafer transporting mechanism 701 being lowered, the semiconductor wafer 101(n) is transferred to the micro wafer holding portion 113.

Moreover, in step S211, the semiconductor wafer 101(n) on the transfer arm 701b is transferred at the micro inspection transfer position P3 to the wafer holding portion 113 by the inspection control unit and is held there by suction. A reference position is also calculated by the alignment sensor 111. This operation is performed in the same way as in step S110 of the first embodiment.

By performing the above described steps S210 and S211, the moving and transferring of the semiconductor wafer 101 using the wafer holding portion 113 is ended.

Next, in step S212, the micro wafer holding portion 113 moves to the micro inspection position.

In contrast, in step S215 the wafer manufacturing process 104 moves to the wafer transfer position P4.

In step S216, the wafer manufacturing process 104 is driven by the transport control unit 303, and the semiconductor wafer 101(n−1) that is at the wafer transfer position P4 is transferred to the wafer manufacturing process 104 and is stored in (i.e., discharged to) the discharge wafer cassette 105.

In step S213′, the wafer manufacturing process 104 extracts the semiconductor wafer 101(n+3) from the wafer cassette 105, moves to the wafer transfer position P1, and prepares to transfer it to the wafer transporting mechanism 701.

When the macro inspection has ended (step S206), the macro inspection oscillating mechanism 109 is lowered and preparations are made to transfer the semiconductor wafer 101(n+1) to the wafer transporting mechanism 701 (step S203′).

When steps S213′ and S203′ have ended, the next inspection cycle can be performed for the semiconductor wafer 101(n+1). Therefore, the above described steps are repeated as is necessary.

In this manner, an inspection cycle is achieved in which macro inspections and micro inspections are performed in sequence on a plurality of semiconductor wafers 101 that are supplied in sequence from the wafer cassette 105, and these semiconductor wafers 101 are then stored in (i.e., discharged to) the discharge wafer cassette 105 in this sequence.

In this manner, according to the visual inspection apparatus 2 of the present embodiment, micro inspection steps (i.e. steps S201 to S207) for the micro inspection for the n^{th} semiconductor wafer 101 and preparatory steps (i.e., steps S202 and S204) for the macro inspection step of the (n+1)^{th} semiconductor wafer 101 can be performed in parallel, and micro inspection preparatory steps (i.e., steps S203 and S202) for the micro inspection for the n^{th} semiconductor wafer 101 and steps (i.e., steps S213 and S214) to transfer the (n+2)^{th} semiconductor wafer 101 to the wafer transporting mechanism 701 can be performed in parallel.

Furthermore, by providing four transfer arms in the wafer transporting mechanism 701 and setting one of them at the wafer transfer position P4, the preparatory steps (steps S209 to S212) for the n^{th} micro inspection step, and the discharge steps to the wafer cassette 105 (steps S208 and S216) can each be performed in parallel with the macro inspection steps (steps S205 and S206) for the (n+1)^{th} semiconductor wafer 101.

As a result, even if there is only one inspector 108, an inspection can be efficiently made.

In the present embodiment a case is described in which the stopping positions of the sequential movement mechanism are also provided at transfer portions of each inspection object.

In the present embodiment, because one arm has been added to the conventional three arms and this additional portion also functions as a buffer portion, the structure can be simplified.

### REFERENCE EXAMPLES

In each of the above described embodiments, a description is given of an example in which the wafer transporting mechanisms 106 and 701 perform turning movements in one direction, however, it is also possible to employ a structure in which the wafer transporting mechanisms 106 and 701 are able to reverse their turning direction so that the inspection order can be appropriately changed. This enables the inspection efficiency to be improved even further.

Below, a description is given of actions resulting from the reverse operation of this type of wafer transporting mechanism using as a reference example a case in which the wafer transfer position P4 and the buffer portion 500 are omitted from the first embodiment and concentrating on points that differ from the above described first embodiment.

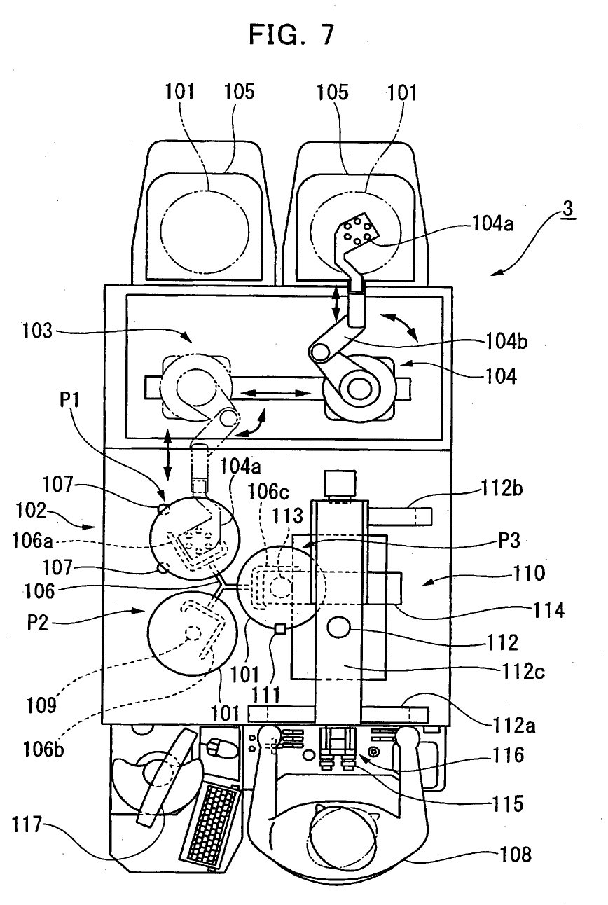

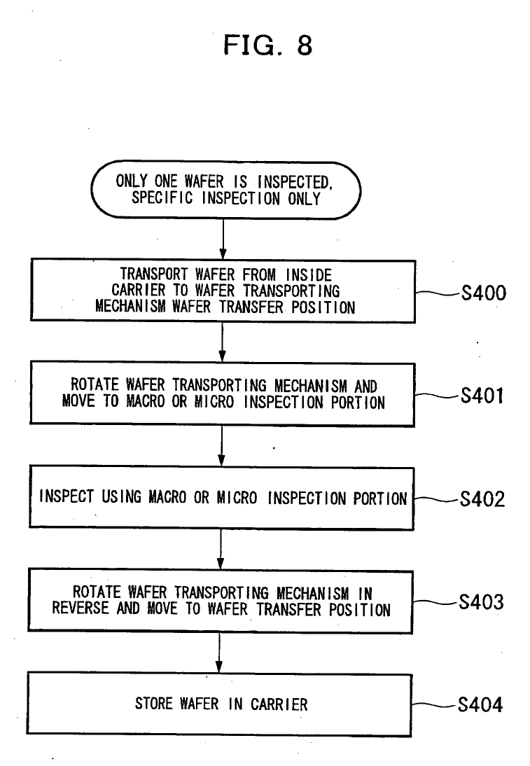

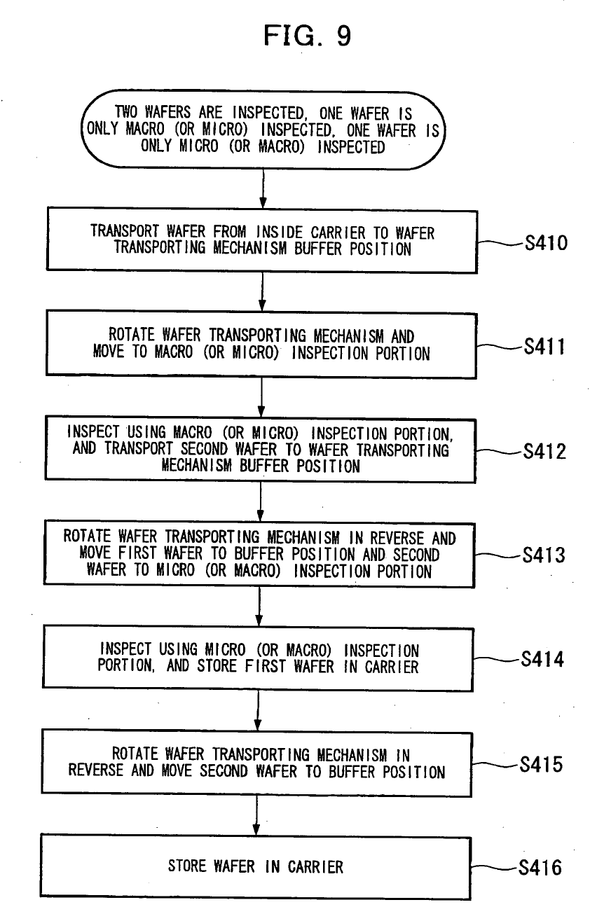

FIG. 7 is a plan view showing the schematic structure of a visual inspection apparatus according to a reference example. FIG. 8 is a flow chart showing an example of an operation of the visual inspection apparatus according to the reference example. FIG. 9 is a flow chart showing another example of an operation of the visual inspection apparatus according to the reference example.

In a visual inspection apparatus 3 of this reference example, the buffer portion 500 has been removed from the visual inspection apparatus 1 of the above described first embodiment. In addition, except for the fact that operations of portions corresponding to the wafer transfer position P4 and the buffer portion 500 in the control unit 201 are not conducted, the control unit has the same structure as the control unit 201.

Next, an example of an operation of the visual inspection apparatus 3 will be described following FIG. 8.

In this operational example, there is only one semiconductor wafer 101, and only the macro inspection or micro inspection needs to be performed.

In step S400, a semiconductor wafer 101 is extracted from the wafer cassette 105, and is transferred to the transfer arm 106a that is positioned at the wafer transfer position P1 where it is held by suction by the transfer arm 106a.

In step S401, the wafer transporting mechanism 106 is turned, however, depending on whether a macro inspection is to be performed or a micro inspection is to be performed, the turning direction of the wafer transporting mechanism 106 is switched either automatically or manually.

For example, if a macro inspection (or micro inspection) is to be performed, the wafer transporting mechanism 106 is turned in an counterclockwise direction (or clockwise direction) as viewed in FIG. 7, and is moved to the macro inspection position P2 (or the micro inspection transfer position P3).

In step S402, an inspection is made using the macro inspection portion 120 (or the micro inspection portion 110).

In step S403, after the inspection has ended, the semiconductor wafer 101 is transferred onto the transfer arm 106a that is positioned at the macro inspection position P2 (or the micro inspection transfer position P3), and is held there by suction. After this, the turning position is reversed and the transfer arm 106a is restored to the wafer transfer position P1.

In step S404, the suctioning of the inspected semiconductor wafer 101 is terminated, the semiconductor wafer 101 is then transferred to the wafer manufacturing process 104, and is discharged to the discharge wafer cassette 105.

According to this type of step, by turning the wafer transporting mechanism 106 in the reverse direction, the wafer sporting mechanism 106 is restored to the wafer transfer position P1 without moving to the micro inspection portion 110 (or the macro inspection portion 120) where no inspection is performed, so that the movement distance can be shortened and the inspection efficiency can be improved.

Next, another example of an operation of the visual inspection apparatus 3 will be described following FIG. 9.

In this operational example, there are two semiconductor wafers 101 and one semiconductor wafer 101 only undergoes a macro inspection while the other semiconductor wafer at 101 only undergoes a micro inspection. These semiconductor wafers are referred to below as semiconductor wafers 101A and 101B and the semiconductor wafer 101A is inspected first while the semiconductor wafer 101B is inspected second.

In step S410, the semiconductor 101A is extracted from the wafer cassette 105, is transferred to the transfer arm 106a that is positioned at the wafer transfer position P1, and is held by suction on the transfer arm 106a.

In step S411, the wafer transporting mechanism 106 is turned counterclockwise as seen in FIG. 7, and is moved to the macro inspection position P2.

In step S412, an inspector 108 makes a macro inspection using the macro inspection portion 120. In contrast, at the same time as this, the wafer manufacturing process 104 is driven and the semiconductor wafer 101B is transferred to the transfer arm 106c that is positioned at the wafer transfer position P1, and is held by suction on the wafer transporting mechanism 106c. Here, the wafer transfer position P1 performs the role of a buffer position that holds the semiconductor wafer 101B which is to be inspected next while the semiconductor wafer 101A is undergoing a macro inspection.

In step S413, after the macro inspection of the semiconductor wafer 101A has ended, the wafer transporting mechanism 106 is turned clockwise, and the semiconductor wafer 101A is moved to the wafer transfer position P1. In addition, the semiconductor wafer 101B is moved to the micro inspection transfer position P3.

In step S414, the semiconductor wafer 101B that has been moved to the micro inspection transfer position P3 is moved by the wafer holding portion 113 to the inspection position, and a micro inspection is made by the inspector 108.

In contrast, the suctioning of the inspected semiconductor wafer 101A that has been moved to the wafer transfer position P1 is terminated and this semiconductor wafer 101A is transferred to the wafer manufacturing process 104. It is then discharged to the discharge wafer cassette 105. This operation is performed automatically by the transport control unit.

In step S415, after the inspection of the semiconductor wafer 101B has ended, the semiconductor wafer 101B is moved to the micro inspection transfer position P3 where it is transferred to the transfer arm 106c and held there by suction. The wafer transporting mechanism 106 is then turned counterclockwise as seen in the drawings, and the semiconductor wafer 101B is moved to the wafer transfer position P1.

In step S416, the suctioning of the semiconductor wafer 101B that has been moved to the wafer transfer position P1 is terminated and this semiconductor wafer 101B is discharged to the discharge wafer cassette 105 by the wafer manufacturing process 104.

According to this process, by selectively turning the wafer transporting mechanism 106 in two directions, the wafer transporting mechanism 106 is restored to the wafer transfer position P1 without moving to a position where no inspection is performed. As a result, the movement distance can be shortened. Moreover, because the empty transfer arm that has been moved to the wafer transfer position P1 after having moved one semiconductor wafer 101 is used as a buffer for the semiconductor wafer 101 to the inspected next, the inspection efficiency can be improved if the semiconductor wafer 101 to be inspected next is to undergo a different inspection from the preceding semiconductor wafer 101.

In this operational example, the inspection order of the semiconductor wafers 101A and 101B is not particularly restricted, and it is of course possible for this order to be reversed.

Note that, in the above descriptions of the respective embodiments, an example is described in which a macro inspection and a micro inspection are performed in this sequence on an inspection object, however, the present invention is not limited to this and a micro inspection may also be followed in sequence by a macro inspection. The operation flow in this case is different from that given in the description of the embodiments above, however, only the flow is different and the operations in each step are essentially the same. Accordingly, the operation flow can be easily understood from the above description. For example, if the wafer transfer position P1 is switched with the wafer transfer position P4, and the sequential movement mechanism is turned in the opposite direction, then an inspection object can be inspected in the sequence of micro inspection followed by macro inspection.

Moreover, in the above description, an example is described in which auxiliary inspection portions are provided in order to make different types of inspection from those of the macro inspection portion 120 and the micro inspection portion 110, however, it is also possible for the auxiliary inspection portions to make preparations for the inspections performed by the macro inspection portion 120 and the micro inspection portion 110. For example, if the inspection sequence begins with a micro inspection, then it is possible to provide the alignment sensor 111 before the micro inspection portion 110 and make preparations such as detecting the position of the inspection object.

Moreover, in the above description, an example is described in which the inspection object transporting portion supplies and discharges an inspection object alternatingly using a single wafer manufacturing process, however, in the present invention, it is also possible to provide a plurality of wafer manufacturing processes that utilize the fact that there are two inspection object transfer portions to supply an inspection object to one and discharge an inspection object from the other. In this case, because it is possible to perform the supplying and discharging of an inspection object simultaneously, the transferring of inspection objects can be performed more rapidly.

Moreover, insofar as is technically possible, component elements described in each of the above described embodiments and reference examples may be suitably combined within the technological scope of the present invention.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A visual inspection apparatus comprising:
at least two inspection object transfer portions that transfer inspection objects to and from storage cassettes;
at least two inspection portions that are located in different inspection positions from each other in order to inspect the inspection objects;
an inspection object moving portion that moves the inspection objects that have been transferred to a main body of the apparatus between the inspection object transfer portions and the inspection portions, or between two of the inspection portions; and
an inspection object transporting portion that transfers the inspection objects between the inspection object transfer portions and the storage cassettes.

2. The visual inspection apparatus according to claim 1, wherein the inspection object moving portion comprises a sequential movement mechanism that moves the inspection objects continuously in sequence between a plurality of stop positions that are provided in at least each of the inspection portions.

3. The visual inspection apparatus according to claim 2, wherein the stop positions of the sequential movement mechanism are also provided in each of the inspection object transfer portions.

4. The visual inspection apparatus according to claim 2, wherein the inspection object moving portion comprises a transfer movement portion that moves the inspection objects at least between one of the inspection object transfer portions and an inspection portion in which the stop position at a distal end of the sequential movement mechanism is provided, or at least between one of the inspection object transfer portions and an inspection portion in which the stop position at a base end of the sequential movement mechanism is provided.

5. The visual inspection apparatus according to claim 1, wherein the inspection object transfer portions also function as auxiliary inspection portions that either make preparations for inspections performed by at least the two inspection portions, or perform a different type of inspection from those performed by at least the two inspection portions.

6. The visual inspection apparatus according to claim 5, wherein the auxiliary inspection portion is an inspection unit that inspects an outer circumferential edge portion of the inspection objects.

7. The visual inspection apparatus according to claim 4, wherein the transfer movement portion is a stage that is capable of moving in two axial directions and capable of moving rotationally within a horizontal plane, and that moves the inspection objects between the inspection object transfer portion and the inspection portion in which the stop position at a base end of the sequential movement mechanism is provided.

8. The visual inspection apparatus according to claim 3, wherein the sequential movement mechanism comprises four transfer arms that extend from a rotation axis that runs in a vertical direction in radial directions separated equally by 90 degrees, and that hold the inspection objects on a fixed circumference at the distal end side in a radial direction.

9. The visual inspection apparatus according to claim 8, wherein two of the stop positions of the sequential movement mechanism are on an inspection object transporting portion side that is provided opposite an operating section.

10. The visual inspection apparatus according to claim 1, wherein the at least two inspection portions comprise a macro inspection portion that inspects the inspection objects by direct view, and a micro inspection portion that enlarges the inspection objects using a microscope and then observes the inspection objects.
